(19) United States
(12) Patent Application Publication
(10) Pub. No.: US 2003/0148652 A1
(43) Pub. Date: Aug. 7, 2003

(54) Plug device for a standard electrical connection cord

(75) Inventors: Christophe Bernardi, Sallanches (FR); Yves Guillot, Bonne (FR); Gabriel Tupin, Vougy (FR)

Correspondence Address: BLANK ROME COMISKY & MCCAULEY, LLP, 900 17TH STREET, N.W., SUITE 1000, WASHINGTON, DC, 20006, US

(73) Assignee: AMPHENOL SOCAPEX

(21) Appl. No.: 10/132,102

(22) Filed: Apr. 26, 2002

(30) Foreign Application Priority Data
Feb. 5, 2002 (FR) 0201321

(51) Int. Cl. H01R 13/58

(52) U.S. Cl. 439/462

(57) ABSTRACT

The invention relates to a plug device for a standard electrical connection cord provided with a cord plug that includes an external mechanical latch having a control lever. The device comprises a plug body; a plug adapter that can be fastened inside the plug body; a packing body including packing; and a link part having a first end for connection with the plug body and a second end for connection with the packing body. The plug adapter has an internal profile suitable for receiving the body of the cord plug and having fastening means for retaining the cord plug body and for holding said latch of the cord plug body in its inactive position.

The present invention relates to a plug device for a standard electrical connection cord provided at at least one of its ends with a plug presenting a body provided with an external mechanical latch.

### BACKGROUND OF THE INVENTION

At present, the main standards for ruggedized industrial networks have been created by the suppliers of control units: PROFIBUS from Siemens, FIP from Télémécanique, etc.

The present trend is to escape from the constraints associated with such suppliers of control units by using a data transfer network on-site that is open, i.e. a network that is not dependent on any particular supplier of control units and that constitutes a genuine worldwide standard.

Ethernet, which is a network already in use in offices for interconnecting computers and their peripherals, satisfies these conditions. The connectors used are known as the “RJ45” type. Connections are constituted by an optionally-shielded standard cord having plugs that are likewise standard mounted at its ends, each plug presenting a body which is provided with an external mechanical latch that can be retracted by pressing on one end of the latch. Naturally, the latch is used for mechanical fixing when making a connection with a jack.

Accompanying FIG. 1 shows the end of a standard cord fitted with a plug of a type that is also standard in the RJ45 system.

There can be seen the cord 10 and its plug 12 which comprises a body 14 that is generally overmolded onto the cord 10. A mechanical latch 16 is provided on the outside face of the body 14, which latch can be moved into an inactive position by a tongue 18 acting as a control lever.

Although that type of connector is well suited to the conditions that apply to the Ethernet standard, it is not at all suited to the industrial production environment in which splashes of liquids, shocks, untimely tugs on the cord, vibration, electromagnetic disturbances, etc., can all be encountered. Connection cords of the RJ45 type present the additional advantage that they are now standard cords which are available ready-calibrated with two over-molded RJ45 plugs, one at each end.

One solution for adapting RJ45 connectors to the constraints of the industrial environment would be to separate the standard cord from its plugs and replace those plugs with plugs of a conventional type used in an industrial environment.

Nevertheless, it will be understood that that would present two drawbacks:

firstly, because of the over-molding, eliminating the original plugs, and then wiring new plugs to the cord would lead to additional costs; and

secondly, the benefit of the cord fitted with its two over-molded plugs being already calibrated is lost, and this runs the risk of reducing overall performance.

### OBJECTS AND SUMMARY OF THE INVENTION

There therefore exists a real need to be able to transform a standard cord fitted with a RJ45 type plug or the like into a standard cord fitted with a plug that is compatible with the industrial environment, while avoiding the drawbacks of the solution outlined above.

To achieve this object, the present invention provides a plug device for a standard electrical connection cord provided at an end with a cord plug having a body which includes an external mechanical latch fitted with a control lever having an active position and an inactive position, said plug device comprising:

a plug body;

a plug adapter having external fastening means for engaging in said plug body;

a packing body including packing of cylindrical shape and a screw thread; and

a link part having a first end for connection with said plug body and a second end provided with a screw thread for co-operating with said screw thread of said packing body;

said plug adapter having an internal profile suitable for receiving said cord plug body and having fastening means for engaging the cord plug body and for holding said latch of the cord plug body in its inactive position;

said packing body, the packing when at rest, and said link part all defining respective internal passages of sufficient size to pass the cord plug body; and

screwing the packing body onto said link part causing said packing to be compressed, thereby clamping said packing onto the standard cord.

It will be understood that by means of the invention is possible to insert the cord plug into the elements constituting the plug device so as to house the plug body inside the protective plug adapter. Furthermore, the plug adapter is shaped in such a manner as to hold the mechanical latch of the cord plug in its inactive position. In this way, the connection between the plug and the corresponding jack is made in conventional manner merely by the plug body.

It should also be emphasized that by compressing the packing, not only is the plug device assembly sealed, but the standard cord is fastened mechanically to the plug device in addition to the main fastening that results from the cord plug co-operating with the plug adapter.

Finally, and above all, the invention makes it possible to adapt the cord to an industrial environment without any need to separate the plug from the cord.

In a preferred embodiment, said plug adapter is constituted by two distinct parts, each defining a portion of the internal profile suitable for receiving said cord plug body, thereby enabling said two parts of said adapter to be put into place in succession on the cord plug body.

It will be understood that in this preferred embodiment, it is easier to mount the cord plug in the insulating adapter, since each of the parts can be put into place in succession in a lateral direction relative to the body of the cord plug.

Also preferably, each part of the plug adapter has a portion in relief forming an abutment suitable for co-operating with a portion of the latch of the cord plug when said latch is in its inactive position. This characteristic is particularly advantageous since in this way axial fastening between the cord plug and the plug adapter is obtained by a portion of the plug which has standardized dimensions. The plug adapter can thus be used regardless of the type or the manufacturer of the cord.

### BRIEF DESCRIPTION OF THE DRAWINGS

Other characteristics and advantages of the invention appear better on reading the following description of various embodiments of the invention given as non-limiting examples.

The description refers to the accompanying figures, in which:

FIG. 1, described above, is a perspective view showing a standard cord with its plug;

FIG. 2 is a perspective view showing the various component elements of the plug device;

FIGS. 3 and 4 are detail views of two parts forming the insulating plug adapter;

FIG. 5 is a side view of one of the parts of the plug adapter;

FIG. 6 is a detail view of the preceding figures showing how the cord plug latches in the plug adapter;

FIG. 7 shows the plug adapter mounted on the cord plug; and

FIGS. 8 and 8A show the last two stages in assembling the plug device.

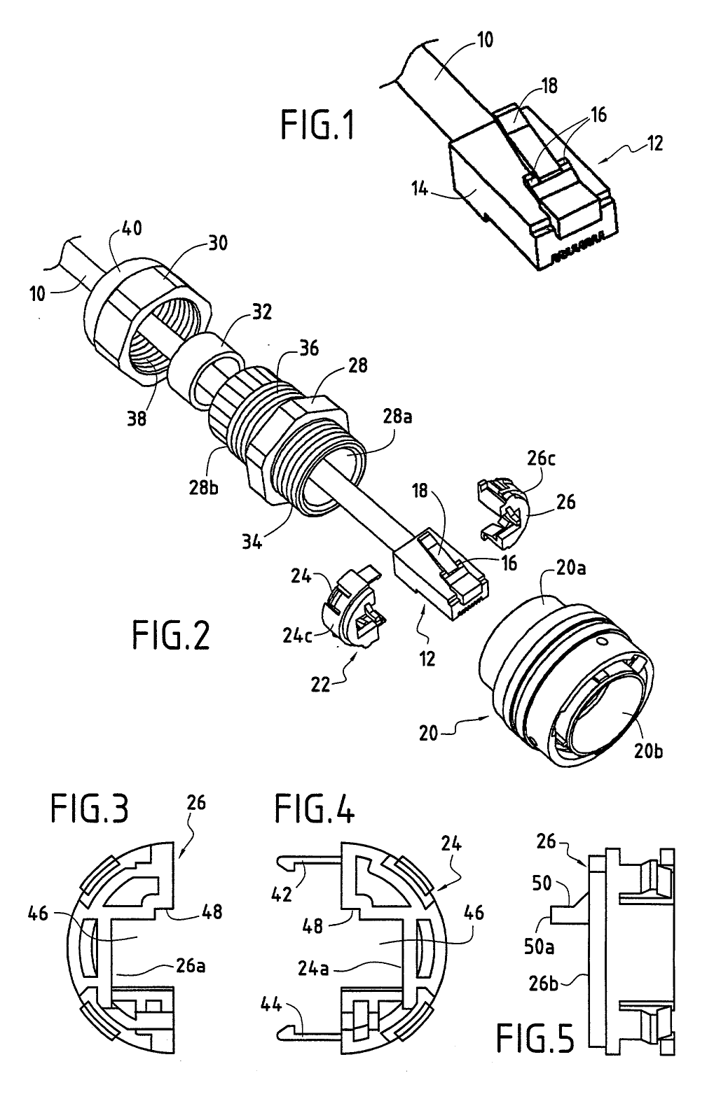

### MORE DETAILED DESCRIPTION

With reference initially to FIG. 2, there follows a description of the plug device assembly of the invention.

It comprises a plug body 20, a plug adapter 22 for the cord plug 10, which adapter is preferably constituted by two distinct parts 24 and 26, a link part 28, and a packing body 30 fitted with packing 32 of cylindrical shape.

The plug body 20 can be of any shape and on the inside it can have means for fastening the plug adapter 22 both axially and radially. It also has bayonet means for connection to a jack body (not shown). The plug body 20 in also has tapping in its rear portion 20a.

The link part 28 has a front portion 28a and a rear portion 28b fitted with oppositely-handed threads 34 and 36.

The packing body 30 has tapping 38 and a rear wall 40 pierced by an axial orifice of sufficient size to allow the plug 12 of the cord 10 to pass through.

In the same manner, the link part 28 and the packing 32 both present an axial passage that is large enough to pass the plug 12 of the cord 10.

With reference now to FIGS. 3 to 6, there follows a description of a preferred embodiment of the plug adapter 22 and of the way in which it is secured to the plug 12.

The adapter 22 can be made of an insulating material, optionally metal-plated with a nickel or a cadmium alloy in order to provide electromagnetic protection.

The parts 24 and 26 forming the adapter 22 can be fastened to each other by clip members 42 and 44. Each part 24, 26 presents internal profiles 24a, 24b, which, once the two parts have been assembled together, define a recess 46 for receiving the body of the plug 12, the recess being surmounted by a groove 48 for receiving the control lever 18 of the plug 12 when it is in its lowered position corresponding to the latch 16 being deactivated.

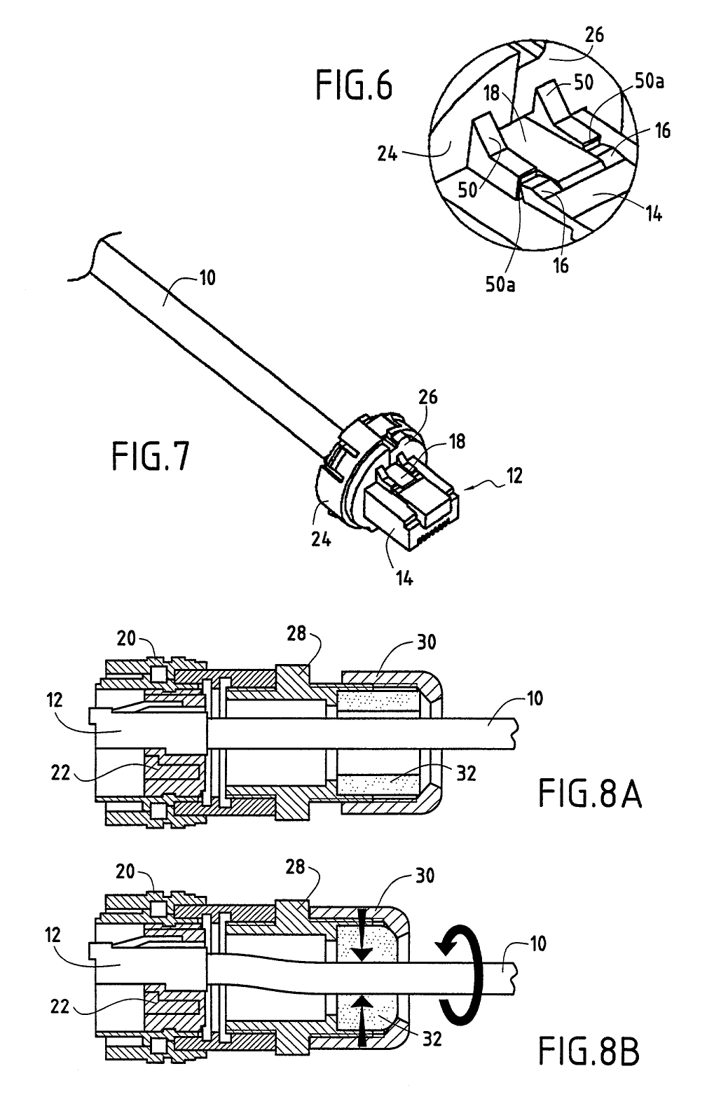

As shown more clearly in FIG. 5, each part 26 (24) has a beam-shaped extension 50 on its front face 26b (24b), and projecting from its front face. The extensions 50 are positioned in such a manner that when the body 14 of the plug 12 is inserted into the recess 46 in the adapter 22 and when the latch 16 is in its deactivated position, the ends 50a of the extensions 50 come into abutment against the latches 16. This is shown clearly in FIG. 6.

With reference now to FIGS. 2, 7, 8A, and 8B, there follows a description of how the plug device is mounted on the plug 12 of the cord 10.

The link part 28, the packing 32, and the packing body 30 are all engaged on the cord 10 beyond the plug 12, as shown in FIG. 2. Then, after pressing the lever 18 of the latch 16 down onto the plug 12, the part 26 of the adapter 22 is put into place. Thereafter, the second part 24 of the adapter is mounted on the plug body 14, thereby causing the parts 24 and 26 simultaneously to snap together. The adapter 22 is then fixed on the body 14 of the plug 12, as shown in FIG. 7.

The plug 12 and the adapter 22 are then inserted into the plug body 20. The outer wall 24c, 26c of the adapter preferably includes a projection, and the inner wall 20b of the plug body 20 has four notches that are offset by 90°. The adapter 22 is thus prevented from turning inside the plug body 20 and it can occupy one out of four coded positions.

Finally, as shown in FIGS. 8A and 8B, the link part 28 is screwed onto the plug body 20, thereby preventing the adapter 22 from moving in translation relative to the plug body. The packing body 30 is then screwed onto the thread 36 of the link part, thereby compressing the packing 32 and clamping it onto the cord 10.

It should be emphasized that the plug 12 is prevented from moving in translation relative to the adapter 22 because the ends 50a of the extensions 50 of the adapter 22 come into abutment against the latch 16 in the deactivated position. The latch 16 is of standardized dimensions. The plug device of the invention can therefore be used with all cords whose plugs have latches complying with the standard.

1/ A plug device for a standard electrical connection cord provided at an end with a cord plug having a body which includes an external mechanical latch fitted with a control lever having an active position and an inactive position, said plug device comprising:
a plug body;
a plug adapter having external fastening means for engaging in said plug body;
a packing body including packing of cylindrical shape and a screw thread; and
a link part having a first end for connection with said plug body and a second end provided with a screw thread for co-operating with said screw thread of said packing body;
said plug adapter having an internal profile suitable for receiving said cord plug body and having fastening means for engaging the cord plug body and for holding said latch of the cord plug body in its inactive position;
said packing body, the packing when at rest, and said link part all defining respective internal passages of sufficient size to pass the cord plug body; and
screwing the packing body onto said link part causing said packing to be compressed, thereby clamping said packing onto the standard cord.

2/ A plug device according to claim 1, in which said plug adapter is constituted by two distinct parts, each defining a portion of said internal profile suitable for receiving said cord plug body, thereby enabling said two parts of said adapter to be put into place in succession on the cord plug body.

3/ A plug device according to claim 2, in which said two parts of said plug adapter are provided with mutual clip means.

4/ A plug device according to claim 1, further comprising an O-ring suitable for co-operating with said packing body and placed on the second end of said link part.

5/ A plug device according to claim 1, in which said packing body has a rear wall provided with an axial opening suitable for passing the body of said cord plug, said wall forming an abutment for said packing.

6/ A plug device according to claim 2, in which the inner profile of said two parts forming the adapter, once assembled together, forms a recess for receiving the body of the cord plug and a groove for receiving said control lever of the cord plug latch in its inactive position.

7/ A plug device according to claim 2, in which the front face of each part of said plug adapter is provided with an extension projecting from said face; the end of each extension forming an abutment for said cord plug latch when in the inactive position.
